(19) United States
(12) Patent Application Publication
(10) Pub. No.: US 2003/0074953 A1
(43) Pub. Date: Apr. 24, 2003

(54) Device for determining the change in the density of a medium

(76) Inventors: Eckard Glaser, Wurzburg (DE); Miroslaw Wrobel, Wurzburg (DE); Janet Grassmann, Eibelstadt (DE)

Correspondence Address: Lorri W Cooper, Jones Day Reavis & Pogue, North Point, 901 Lakeside Avenue, Cleveland, OH, 44114, US

(21) Appl. No.: 10/110,450

(22) PCT Filed: Jan. 19, 2001
(86) PCT No.: PCT/EP01/00579

(30) Foreign Application Priority Data
Jul. 27, 2000 (DE) 10036565.5

(51) Int. Cl. G01N 9/00

(52) U.S. Cl. 73/32 A

(57) ABSTRACT

The invention relates to a device for determining the change in the density of a solid, liquid or gaseous medium. Said device is able to detect effects on the density of the medium caused by physical and/or chemical parameters which cause changes in the density of the medium. The device comprises an emission device (2) for emitting any kind of emission signal having at least one period. Said emission device is coupled to the medium (3). At least one receiving device (7) picks up the response signals which are reflected and/or transmitted from the medium. A comparator (6) follows each receiving device, the receiving device being connected across one input of the comparator and the emission device being respectively connected across the other input thereof. The outputs of the comparators are coupled to a processing and sample selecting device which is followed by a display screen (9).

The invention refers to a device for detecting changes in the density of a solid, liquid or gaseous medium. In particular, the device is capable of measuring the effects of physical and/or chemical parameters, causing changes in the density and/or compression constants of a medium, for instance, occurring due to temperature and pressure changes in chemical, biochemical and physical reactions on the density of a medium.

It is a known fact that changes in temperatures and pressures are detected by conventional means for measuring temperature and pressure. However, these means will fail when a medium is not accessible or is in an environment, in which no measuring devices can be introduced. In addition, these changes are frequently so minute that very expensive measuring devices are required for detection.

In many processes, changes in temperature and/or pressure are only an indication for the fact that a medium has reached a desired property, for instance an oil having the required viscosity or that sensitive deep-frozen products have thawed. A chemical, biochemical or physical process need not always be associated with changes in temperature or pressure. Consequently, temperature and/or pressure measurements cannot be used for proving that a process of that nature is taking or has taken place. In these cases, determination of the condition is frequently effected via a number of alternative routes, which are time-consuming and costly.

It is therefore the task of the present invention to suggest a device, by which a change in the structural properties of a solid, liquid or gaseous medium may be determined at minimum cost. The device should also be suitable for determining the structural properties of media in sealed containers that are inaccessible or hard to access.

The invention is solved by the characteristics of the main claim. Sub-claims refer to specific designs and developments. The device for detecting changes in he density of a medium comprises a transmitter unit for transmitting an arbitrary send signal, with the said send signal comprising at least one period and the transmitter unit being coupled to the medium. Furthermore, as least one receiver unit is available for receiving the reflected and/or transmitted response signals from the medium, with each receiver unit being followed by one comparator and each receiving unit being coupled to an input of the comparator and the transmitter unit being connected to the other input of the comparator. The outputs of the comparator(s) are coupled to a processing and selection unit, followed by a display.

A particularly beneficial design of the present invention is realised when the send signal is of a constant frequency and amplitude.

This device for determining the change in the density of a medium will measure the phase shift between the send signal and the receive signal, also changing when the density of the medium changes. Consequently, this device may track changes in the density of a medium. At the beginning of the measurement, a phase shift may already exist between the send signal and the receive signal. Changes in the structural properties of the medium will then cause another phase shift, which will be evaluated.

In a further development of the device, an adjustable time delay element may be connected between the transmitter unit and each (the) comparator and the output(s) of the comparator(s) may be connected to a switched feedback that leads to the adjustable time delay elements. This device may be calibrated when measurements are started, i.e. the phase shift between the send signal and the receive signal may be set to zero when measurements are started. When another phase shift occurs, this is exclusively due to changes in the density of the medium, occurring after calibration. When using an arbitrary send signal, for instance, the time delay element comprises a DSP processor and an adaptive filter. In this case, the phase shift must be measured for each frequency contained in the send signal. These phase shifts are then used to determine the phase shift of the send signal.

Transmitter and receiver units of this device must always be aligned to each other in a position that ensures reception of the best possible receive signal. This alignment must remain constant during the measuring cycle. It is therefore beneficial when more than one receiver unit is available, which are provided as a two- or one-dimensional array. The strongest receive signal is then used for tracking changes in the density.

In other designs of the present invention, the send signal may be an acoustic wave, such as an ultrasonic wave. This device is eminently suited for medical examination, although ultrasound has also proven to be of benefit in metallurgy.

For some applications it is of benefit to transmit the send signal permanently or subject to a specified time pattern. The time pattern may also include large intervals between the send signals, due to changes in the density of the medium being inherently slow.

Another design only comprises one transmitter/receiver unit, which consists of a reversible sensor. In this case, the maximum length of the send signal is only equal to twice the distance between the sensor and the reflection point of the signal in the medium, in order to obtain a defined send signal on the one hand and to eliminate other interfering signals on the other.

When using the device, initially the present condition is set, i.e. the 0-line, which is the reference for any changes found. This “0-line” may occur due to the phase shift between the send signal and the receive signal at the point in time when the device is connected to a medium or due to an actual 0-line, generated by compensation of this phase shift in the first measuring cycle. For this so-called calibration, the device comprises a switched time delay element. For calibration, initially the send pulse generated by the transmitter unit is simultaneously conducted through the medium and the time delay element. The two pulses, received from the time delay element and/or the receiver unit as a transmission pulse or reflection pulse, are transmitted to a comparator. When detecting a phase shift between the two pulses, the time delay element is set by the feedback, in order to eliminate the phase shift, thus causing no phase shift to exist between the two pulses. This calibrates the device, i.e. it is set to an actual “0-line ” and the feedback is switched off. When several receiver units exist, each receiver channel must be calibrated. For determining further changes in the density of the medium, the receiver channel receiving the largest amplitude of receive signal may be selected. After this, reoccurrence of phase shifts between the send signal and the receive signal is only due to changes in the run time of the send pulse through the medium. This change in the run time may also occur when a flowing liquid or gaseous medium changes its speed. The largest amplitude may then be received by another receiver channel. Individual receiver units may be provided as a two- or one-dimensional array in a specified direction. The direction for a one-dimensional array may, for instance, be specified by the flow velocity of a liquid or gaseous medium.

The measuring method according to the present invention is based on the following dependency:

$${T}_{p} = \frac{L}{V}$$

Where Tₚ is the run time of the pulse through the medium, V the propagation speed of the pulse through the medium and L the path between the transmitter unit and the receiver unit. Changes in one of these parameters will change the run time and therefore the phase relationship of the two pulses. When the length is changed, for instance due to a change in temperature or pressure, a change in the run time ΔTₚ and therefore a phase shift will occur through ΔL. A change in the medium, such as its density or compression module, will cause a change in the propagation speed V and therefore also an ΔTₚ and a respective phase shift in the two pulses. These relationships also show that the absolute path between the transmitter unit and the receiver unit is no longer included in the measurement, for as long as it maintains at its original value.

When a good echo can be obtained in an arrangement, the device should be used in reflection mode. In all other cases, it would be better to use it in transmission mode. A two-dimensional array of individual receivers may facilitate identifying the best echo.

This device allows fast and easy detection of changes in the structural quality of a medium. The cause for these changes may be known but need not be. Should a substance be of a specific viscosity, one is able to determine when this is reached. Should tissue, for instance, fill with water or blood or should these have to be eliminated from tissue by therapeutic measures, changes in its condition and the speed, by which this is effected, may be accurately assessed.

Another application results in the chemical industry. When a chemical reaction is monitored, for instance, the point in time at which a reaction starts and ends may be accurately determined. In these cases, only previously obtained accurate readings of send pulse run times through the transmission path of interest within the medium will be required.

In power stations, this device may be used, for instance, for monitoring the condition of steam for driving turbines. When a receiver unit is provided on the pipe wall of a steam feeder pipe in a linear array in the flow direction of the incoming steam, receiving the send pulse transmitted or reflected, a speed change of the steam may also be detected by individual receiver cells of the linear receiver unit, when more than one receiver is used for the evaluation of receive signals.

Use of the device will therefore be beneficial in all cases where changes in the condition of a medium are providing a positive or negative statement, causing demand for action depending on the type of change or speed at which this occurs. In the process, it may be absolutely possible that the required reactions to any change detected in the density of the medium will be automatically initiated.

The device is simple and low-cost and will not require any complex measuring cycles. For medical emergency services it will yield fast and secure information of whether blood or any other body fluid, for instance, flows into the brain or any other part of the body, as this will cause changes in the density of tissue. Additional measurements will then ascertain whether therapeutic or emergency measures will lead to the desired success.

The invention will be described in the following by means of one embodiment, where identical references used in the drawings apply to identical or similar components.

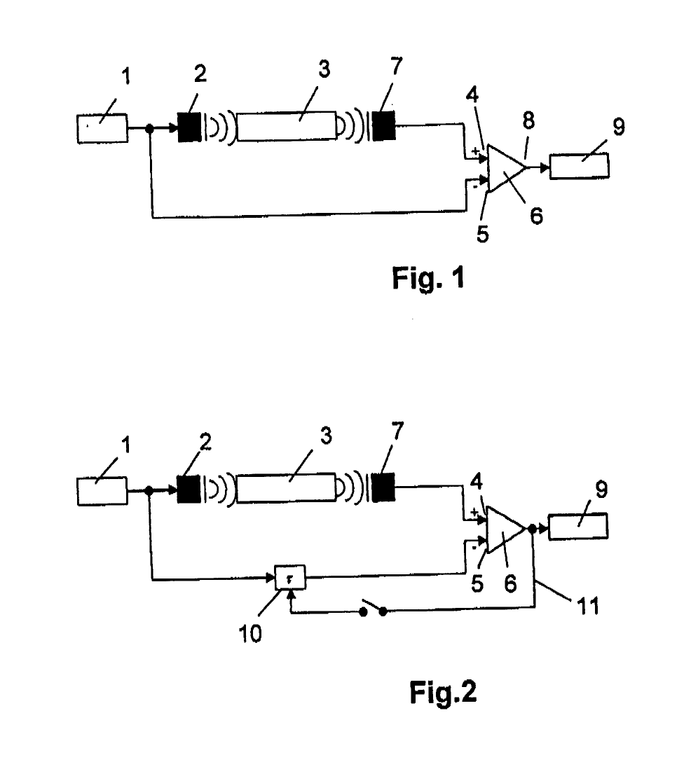

FIG. 1 shows a first embodiment of a device for detecting changes in the density of a medium according to the present invention,

FIG. 2 shows a second embodiment of a device for detecting changes in the density of a medium according to the present invention;

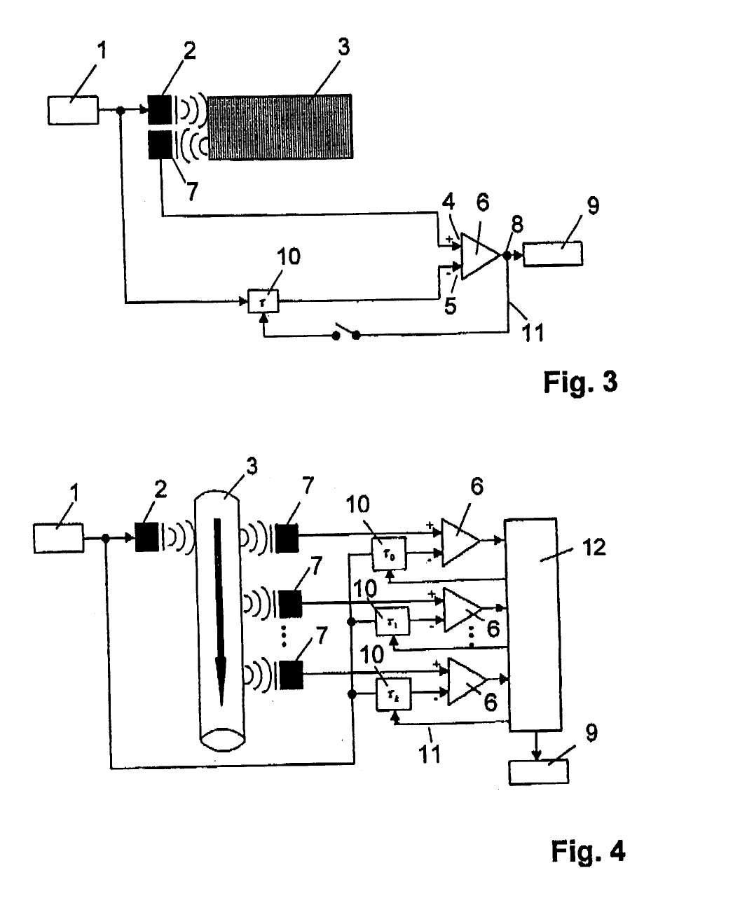

FIG. 3 shows a third embodiment of a device for detecting changes in the density of a medium according to the present invention; and

FIG. 4 shows an embodiment of a device for detecting changes in the density of a medium comprising more than one receiver channel.

In FIG. 1, a first embodiment is shown of a device for detecting changes in the density of a medium according to the present invention in the most simple arrangement. The device for detecting changes in the density of a medium 3 comprises a generator 1 and a transmitter unit 2 for transmitting a send signal having a constant frequency and amplitude and comprising at least one period. The transmitter unit 2 is coupled to the medium 3 and a first input 4 of a comparator 6. For reception of any response signals transmitted from the medium 3, a receiver unit 7 is provided, coupled to the second input 5 of the comparator 6, the output 8 of which is connected to a display 9. The comparator 6 will initially determine the phase shift between the send signal and the receive signal of the receiver unit 7. This phase shift is used as a reference. Changes in density will cause changes in the original phase shift

FIG. 2 shows a second embodiment according to the present invention. In this case, the device for detecting changes in the density of a medium has been expanded by the connection of an adjustable time delay element 10 between the transmitter unit 2 and the first input 4 of the comparator 6, thus passing the send signal simultaneously through the medium 3 and the time delay element 10. In addition, the output 8 of the comparator 6 is connected to an adjustable time delay element 10 by a switched feedback 11. This arrangement allows compensation of the phase shift measured between the send signal and the receive signal detected after the first send signal. Changes in the density of the medium 3 are then referenced to a phase shift of zero. Thus, this device may also be calibrated.

FIG. 3 shows a third embodiment of a device for detecting changes in the density of a medium according to the present invention. The drawing shows a generator 1, a transmitter unit 2, a medium 3, in which the send signal is reflected, a receiver unit 7, a comparator 6, to the inputs 4 and 5 of which the receive signal from the receiver unit 7 and the signal from the time delay element 10 are transmitted. The output 8 of the comparator 6 is connected to a display 9. In addition, a switched feedback 11 is transmitted from the output 8 of the comparator 6 to the time delay element 10.

In this design, the device for detecting changes in the density of a medium may be beneficially used in medicine for monitoring patients. It is a known fact that large volumes of body fluid or blood may have penetrated into a the patient's head after a trauma of the brain. The device may be used, for instance, for assessing the patient's present condition on the site of an accident or the location where a patient became unconscious, without the exact cause being known. For this purpose, the transmitter unit and the receiver unit, comprising a reversible sensor, are applied to the side of the head, just above the ear, as this may generate a good echo of the send pulse on the cranial wall opposite. When a cranial injury has been suffered, another site may have to be selected for the sensor for generating a reflection signal or a device must be used in transmission mode. By means of the time delay element 10, a possible phase shift between the send signal and the receive signal may be compensated through the medium 3. After this, the time delay element 10 will be switched off. Observation of the phase shift, occurring after this between the send signal and the receive signal through the medium 3, may provide an indication for whether the condition of a patient is improving or worsening. When bleeding occurs in the brain, a negative phase shift will occur. Should any accumulation of body fluid be reduced, a positive phase shift will occur. Consequently, the device will detect a local change in the density of the brain.

FIG. 4 shows a fourth embodiment of a device for detecting changes in the density of a liquid or gaseous medium according to the present invention. The device for detecting changes in the density of a liquid or gaseous medium 3 comprises a generator 1 and a transmitter unit 2 for transmitting a send signal of a constant frequency and amplitude and at least one period. In this case, the receiver unit 7 comprises more than one receiver cell. These receiver cells may be provided as a two-dimensional array, for instance, for detecting the strongest echo, which may be used for measuring a change in condition. In this device, the number of comparators 6, connected to the receiver unit 7, is equal to the number of receiver cells in the receiver unit 7, provided as a one-dimensional array, i.e. with each receiver channel comprising one receiver cell, a comparator 6, a time delay element 10 and a switched feedback 11.

On the opposite side of the medium 3, for instance, a receiver unit 7 may also be provided in a one-dimensional array in the flow direction of the liquid or gaseous medium 3. In that case, the frequency of the signal must be selected in order to allow the send signal to be carried by the liquid or gaseous medium 3. Depending on the velocity of the liquid or gaseous medium 3, the send signal will be carried over a different distance, followed by impinging on an appropriate single receiver of the receiver unit 7 provided in a one-dimensional array. However, this change in speed is not explicitly determined but constitutes one component only of the total change. The outputs 8 of the comparators 6 are connected to a processing and selection unit 12, in which the phase shifts between the send signal and individual receive signals are determined. This allows to monitor all receiver channels or only a specific one, which has been selected by set criteria. The processing and selection unit 12 is connected to a display 9. As previously explained for the second and third embodiments, phase shifts are detected between the send signal and individual receive signals of the receiver unit 7 for calibration of the device in individual comparators 6. These phase shifts are then compensated by the switched feedbacks 11 through the time delay elements 10, with changes in density causing phase shifts between the send signal and individual receive signals of the receiver unit 7.

1. Device for determining changes in the density of a medium, characterized by the presence of a transmitting device for the emission of an arbitrary transmit signal, whereby the transmit signal has a minimum of one period and the transmitting device is coupled with the medium, there is at least one receiving device which is to receive the reflected and/or transmitted signals from the medium, of which each is followed by a comparator, whereby the receiving device is always connected to the one input and the transmitting device is connected to the other input of the comparator. The output outlets of the comparator are coupled with a processing and selection device, which is followed by a display unit.

2. Device for determining changes in the density of a medium according to claim 1, in which the transmitted signal has constant frequency and amplitude.

3. Device for determining changes in the density of a medium according to claim 1 or 2, in which adjustable delay elements are linked between the transmitting device and the comparators. The output outlets of the comparators are connected over an optional feedback with the delay elements.

4. Device for determining changes in the density of a medium according to claim 3, in which several receiving units are present, which are arranged in the form of a two-dimensional or a one-dimensional array.

5. Device for determining changes in the density of a medium according to one of the claims 1 to 4, which is characterized by the fact that the transmitted signal is an acoustic signal.

6. Device for determining changes in the density of a medium according to one of the claims 1 to 5, in which the transmit signal is transmitted permanently or according to a predefined time frame.

7. Device for determining changes in the density of a medium according to one of the claims 1 to 6, characterized by the fact that the transmitting and receiving devices consist of a single convertible sensor, and that the length of the transmitted signal is at the most equal to twice the distance between the sensor and the reflection point of the transmitted signal in the medium,
